(19) United States
(12) Patent Application Publication
(10) Pub. No.: US 2013/0151769 A1
(43) Pub. Date: Jun. 13, 2013

(54) Hard Disk Drive Reliability In Server Environment Using Forced Hot Swapping

(71) Applicants: Philip Lee Childs, Raleigh, NC (US); Donald R. Frame, Apex, NC (US); Michael Scott Mettler, Durham, NC (US); Kenneth Dean Timmons, Raleigh, NC (US)

(72) Inventors: Philip Lee Childs, Raleigh, NC (US); Donald R. Frame, Apex, NC (US); Michael Scott Mettler, Durham, NC (US); Kenneth Dean Timmons, Raleigh, NC (US)

(21) Appl. No.: 13/324,985

(22) Filed: Dec. 13, 2011

(51) Int. Cl. G06F 12/00

(52) U.S. Cl. 711/114; 711/E12.001

(57) ABSTRACT

An approach is provided to inactivate a selected drive included in a RAID configuration. While inactive, write requests are handled by identifying data blocks to be written to each of the RAID drives. The identification also identifies a data block address corresponding to the data blocks. Data blocks destined to non-selected drives are written to the non-selected drives. The data blocks destined to the selected drive is written to a memory area outside of the RAID configuration. The data block addresses corresponding to the data blocks are also written to the memory area. After a period of time, the selected drive is reactivated. During reactivation, the data block addresses and their corresponding data blocks that were written to the memory area are read from the memory area and each of the data blocks are written to the selected drive at the corresponding data block addresses.

### TECHNICAL FIELD

The present disclosure relates to an approach that improves disk reliability by periodically disabling drives included in a RAID configuration for a period of time allowing the disabled drives to rest and consequently improve reliabiity.

### BACKGROUND OF THE INVENTION

RAID is an acronym for “Redundant Array of Independent Disks” which is a storage technology that provides increased reliability and functions through redundancy. RAID technology includes computer data storage schemes that can divide and replicate data among multiple physical drives. Various quality levels of drives are currently marketed. “Enterprise-class drives” are typically found in robust environments that often require continuous availability around the clock and every day of the year. Enterprise-class drives are often found as storage utilized in online-accessible servers and the like, such as used in web sites, etc. In contrast, desktop-class drives are found in less robust environments, such as found in a typical user's computer system. Enterprise-class and desktop-class drives differ in a number of criteria such as error recovery time limits, rotational vibration tolerances, error correction-data integrity, and other quality features. The differences in criteria generally allow the enterprise-class drives to operate in a robust environment that might cause their desktop-class drive counterparts to fail. Because of the more robust quality criteria found in enterprise-class drives, the cost of enterprise-class drives is typically considerably higher than the cost of desktop-class drives of otherwise similar specifications (e.g., capacity, speed, etc.).

### SUMMARY

An approach is provided to inactivate a selected drive included in a RAID configuration that provides data redundancy by using a predefined RAID algorithm. While the selected drive is inactive, write requests are handled by identifying data blocks destined to be written to each of the drives included in the RAID configuration including the selected drive. The identification of the blocks to be written to the various drives is based on the RAID algorithm. The identification further identifies a data block address that corresponds to each of the data blocks. The data blocks destined to one or more non-selected (active) drives are written to the non-selected drives at the corresponding data block addresses. The data block destined to the selected (inactive) drive is instead written to a memory area outside of the RAID configuration. In addition, the data block address corresponding to the data block destined to the selected drive is also written to the memory area. After a period of time, the selected drive is reactivated. During reactivation, the data block addresses and their corresponding data blocks that were written to the memory area are read from the memory area and each of the data blocks are written to the selected drive at the corresponding data block addresses.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a diagram showing data being written to a RAID configuration with one of the drives in the configuration being temporarily inactivated;

FIG. 4 is a diagram showing data being read from the RAID configuration with the one drive temporarily inactivated;

FIG. 5 is a flowchart showing steps performed by a RAID controller to use desktop-class drives in a robust environment by inactivating the drives periodically; and

FIG. 6 is a flowchart showing steps by the RAID controller to reactivate a drive that was previously deactivated.

### DETAILED DESCRIPTION

Certain specific details are set forth in the following description and figures to provide a thorough understanding of various embodiments of the invention. Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention. Instead, the following is intended to provide a detailed description of an example of the invention and should not be taken to be limiting of the invention itself. Rather, any number of variations may fall within the scope of the invention, which is defined by the claims that follow the description.

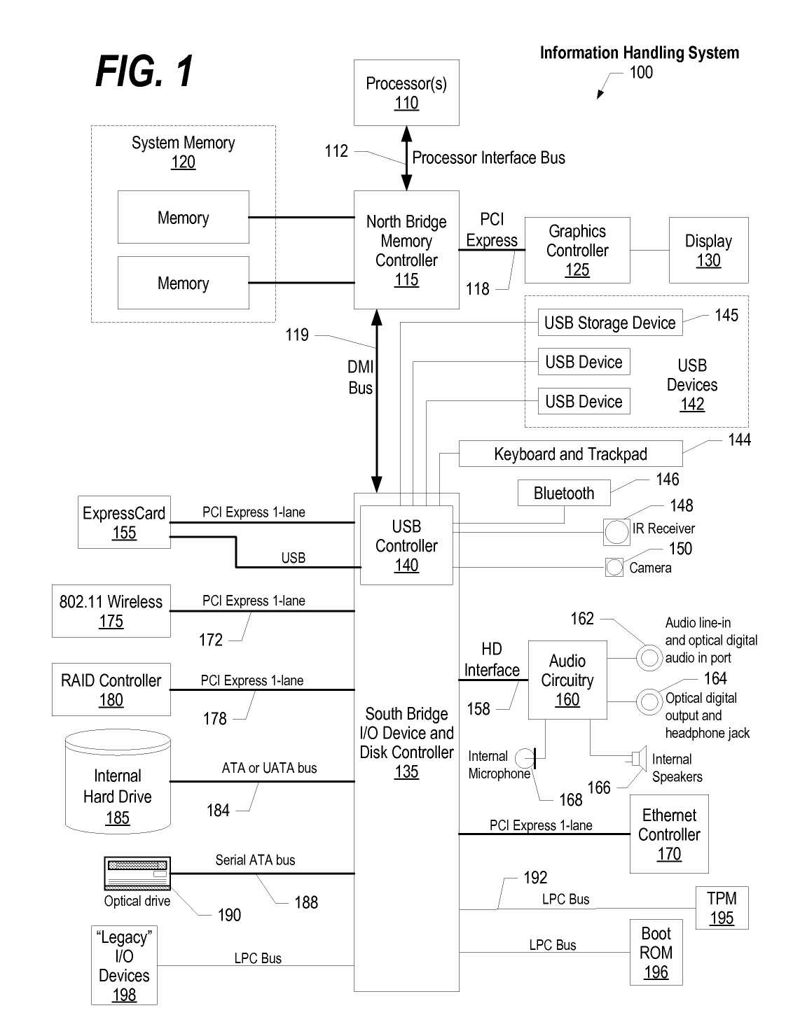

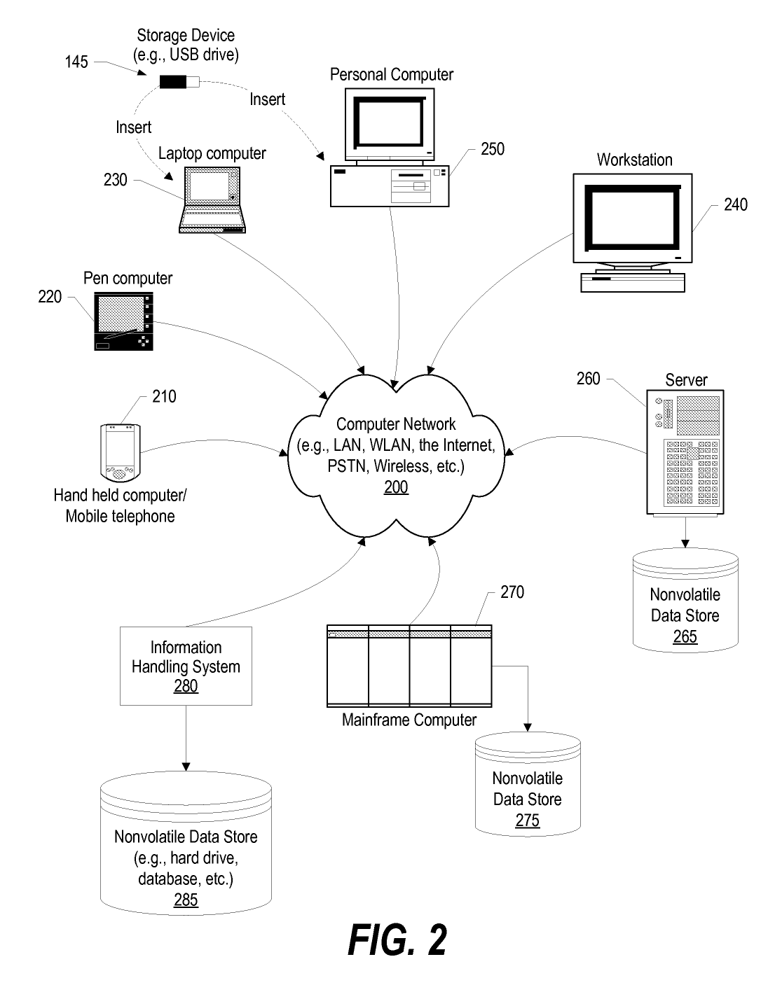

The following detailed description will generally follow the summary of the invention, as set forth above, further explaining and expanding the definitions of the various aspects and embodiments of the invention as necessary. To this end, this detailed description first sets forth a computing environment in FIG. 1 that is suitable to implement the software and/or hardware techniques associated with the invention. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184. RAID controller 180 is used to provide a hardware-based RAID configuration attached to system 100 via PCI Express 1-lane interface 178. The RAID configurations described herein can be either hardware-based or software-based RAID configurations.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

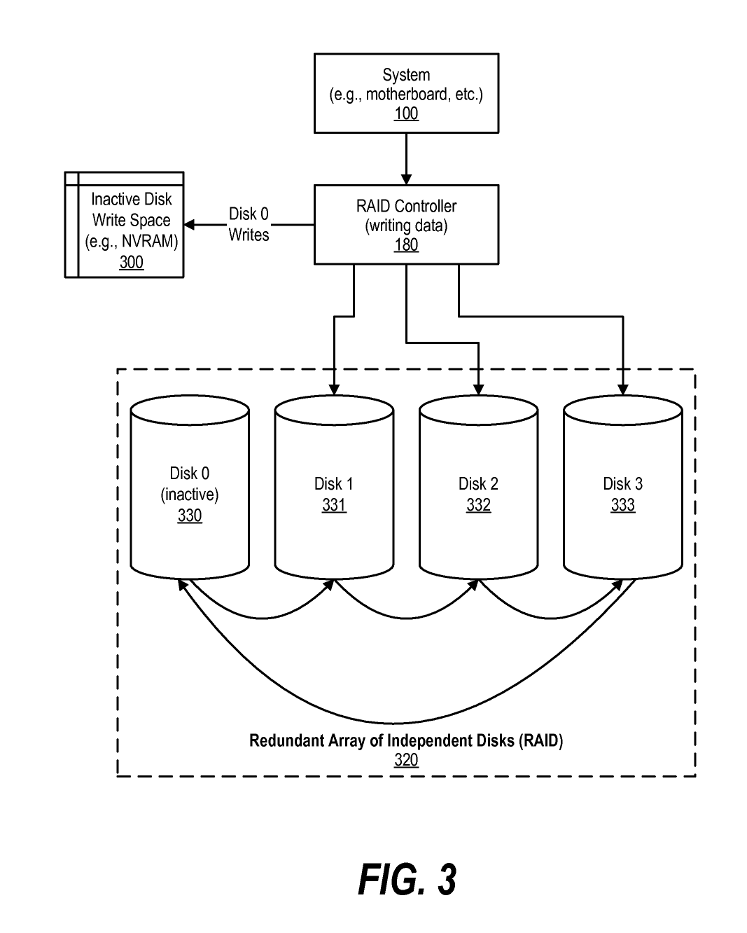

FIG. 3 is a diagram showing data being written to a RAID configuration with one of the drives in the configuration being temporarily inactivated. System 100, such as a motherboard found in an information handling system, etc., communicates with RAID Controller 180 which controls a redundant array of independent disks 320. In the example shown, a set of four drives are included in the array (disk 0 (330), disk 1 (331), disk 2 (332), and disk 3 (333)). A RAID configuration that provides data redundancy is used. For example, a RAID level, such as RAID 0, that provides striping but no redundancy is not used, while a RAID level, such as RAID 5, that provides block-level striping with distributed parity might be used. Any RAID level (or algorithm) can be used so long as the RAID algorithm that is used provides data redundancy, as further described below. While a hardware-based RAID controller (controller 180) is shown, it will be appreciated by those skilled in the art that a software-based RAID controller could be used in lieu of a hardware-based RAID controller. Inactive disk write space 300 is a memory area where data destined for the inactive drive is written while the drive is inactive. A drive from array 320 is selected to be inactive for a period of time. In the example shown, Disk 0 (330) is the selected drive. In one embodiment, a cyclical approach is provided so that each drive is inactivated for a period of time. In this manner, non-enterprise level drives can be used and the drives will generally last longer in the high-usage RAID environment because each of the drives is able to periodically “rest” and remain inactive for a period of time. The arrows below the drives show the cyclical approach where the selected (inactive) drive moves from one drive to the next so that each drive is able to rest. When a drive is selected it is made inactive (e.g., powered off, etc.). Data that would normally be written to the selected drive is instead written to memory area 300 along with the block address where the data would be written per the RAID algorithm that is being used. In one embodiment, when using a hardware-based RAID controller, memory area 300 is a nonvolatile memory located on the RAID controller. In another embodiment, the memory is located off the RAID controller (e.g., system memory, etc.). When a write request is received at RAID controller 180, the RAID controller determines the data blocks that are to be written to the various drives (330 through 333) based on the RAID algorithm (e.g., RAID level 5, etc.) that is being utilized. When a drive, such as Disk 0 (330) is inactive, the RAID controller writes the block address and the data to memory area 330. Data destined to active drives, such as Disks 1 though 3, are written to the active drives at the proper addresses by the RAID controller.

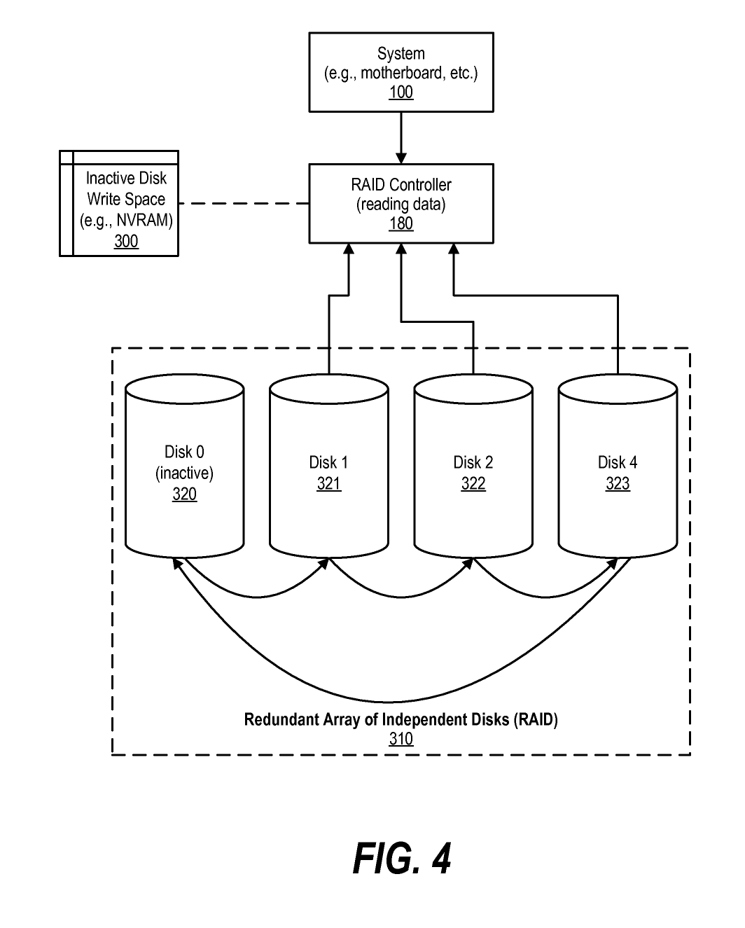

FIG. 4 is a diagram showing data being read from the RAID configuration with the one drive temporarily inactivated. FIG. 4 is similar to FIG. 3, however in FIG. 4 a read request is being processed by RAID Controller 180. When a read request is received, the RAID controller identifies the responsive data on the active drives using the data redundancy built into the RAID algorithm (e.g., RAID level 5) that is being used by the RAID controller to manage the RAID configuration. In this manner, the selected drive (e.g., Disk 0 (330)) is treated as a failed drive with the data that would normally be retrieved from the selected drive being gathered from the active drive using the data redundancy built into the particular RAID algorithm that is being used. For example, when RAID 5 is used, the algorithm distributes parity along with the data and requires all drives but one (the selected drive that is inactive) to be present to operate. In RAID 5, the array is not destroyed by a single drive failure. Instead, in RAID 5, when the selected drive is inactive, any subsequent reads can be calculated from the distributed parity that is distributed amongst the active drives. In this manner, the fact that one of the drives is inactive is masked from the end user.

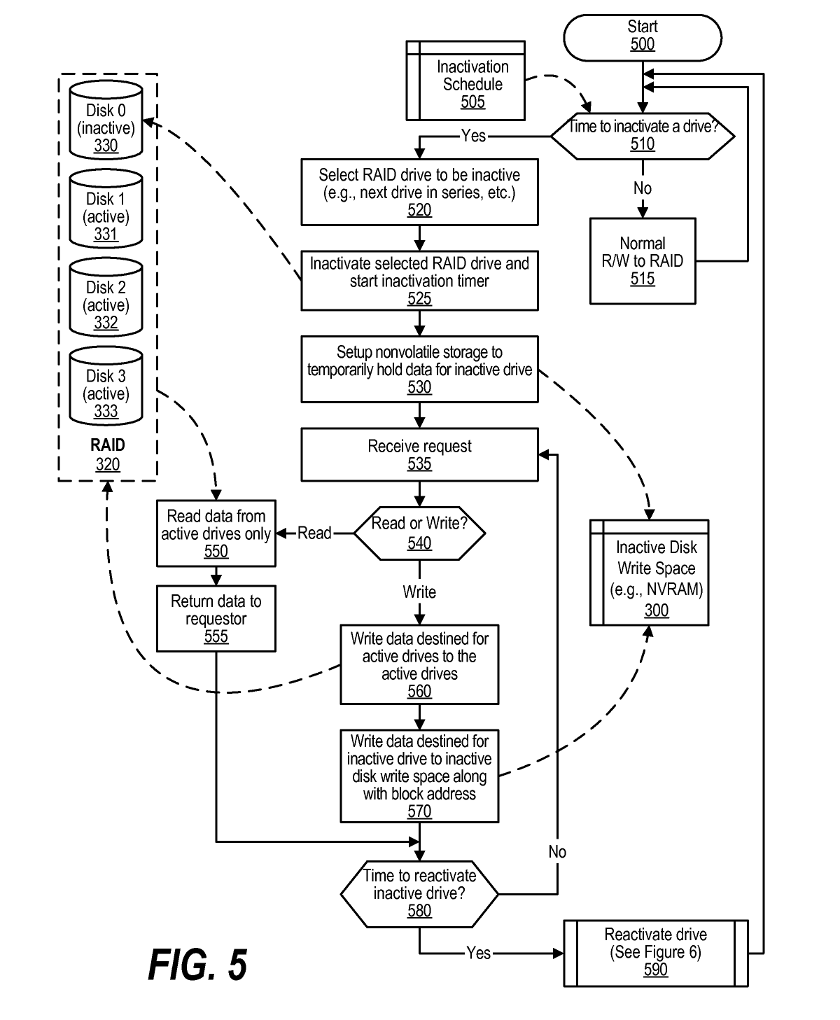

FIG. 5 is a flowchart showing steps performed by a RAID controller to use desktop-class drives in a robust environment by inactivating the drives periodically. Processing commences at 500 whereupon a decision is made as to whether it is time to inactivate one of the drives included in the RAID configuration (decision 510). In one embodiment, an inactivation schedule is used to identify the time at which a drive is to be selected as well as the particular drive in the RAID configuration that is selected. In this embodiment, inactivation schedule 505 is retrieved from a memory area (e.g., a memory accessible to the RAID controller, etc.). The inactivation schedule can be used to keep track of which drive is the next drive to be selected when the drives are inactivated in a cyclical fashion. In addition, the inactivation schedule can be used to determine the amount of time that the drive is inactive.

If it is not time to inactivate one of the drives in the RAID configuration, then decision 520 branches to the “no” branch whereupon normal RAID operations are used to read and write data to all of the drives in the RAID configuration with none of the drives being inactive. Depending on the amount of inactive time desired per drive, normal operation using all of the drives in an active fashion may continue for some time. For example, a schedule could be established allowing normal operations for some amount of time (e.g., an hour, etc.) and then one of the drives is selected and inactivated for some amount of time (e.g., a half hour, etc.) followed by normal operations for an amount of time (e.g., another hour, etc.), followed by the next drive in the configuration being inactivated for an amount of time (e.g., a half hour, etc.) and so on. In this fashion, each drive is able to occasionally rest for a period of time so that the drive is not continuously used for an overly extended period which may otherwise cause the drive to prematurely fail.

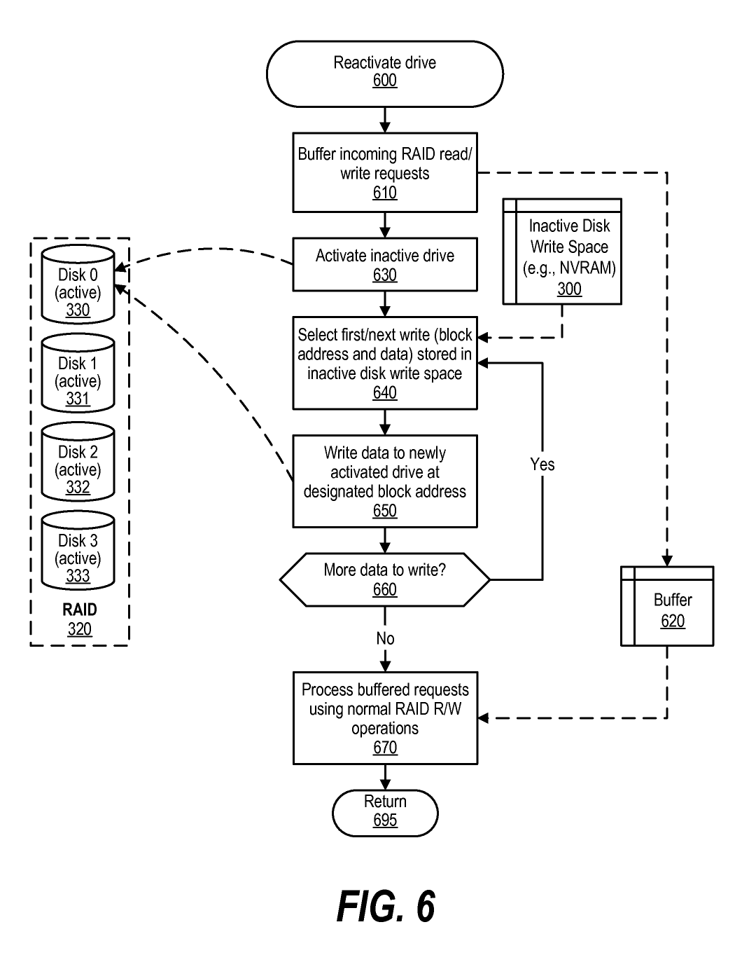

Returning to decision 510, if it is time to inactivate one of the drives included in the RAID configuration, then decision 510 branches to the “yes” branch whereupon, at step 510, a drive is selected from the RAID configuration (e.g., the next drive in the series is cyclically selected, etc.). At step 525, the selected drive is inactivated. In the example shown, Disk 0 (330) is selected from RAID configuration 320. In a cyclical implementation, after Disk 0 is reactivated, the next drive to be selected would be Disk 1(331), followed by Disk 2 (332), followed by Disk 3, and so on until the last drive in the configuration is selected, at which point the selection would revert back to the first drive (Disk 0 (330)) and the inactivation process would continue. In addition, at step 525, a trigger, such as a timer, etc. is initiated so that when the trigger occurs (e.g., a half hour of inactive time, etc.) the inactive drive will be reactivated as shown in FIG. 6. At step 530, a memory area outside of the RAID configuration (not one of the drives included in the RAID configuration) is setup to temporarily store data that was destined for the selected (inactive) drive, in this case Disk 0 (330). In one embodiment, the memory area is a nonvolatile RAM memory so that, in case of power failure, the data stored in the memory area can be recovered.

While the selected drive is inactive, processing of requests received at the RAID controller (software or hardware implemented controller) are handled as shown in steps 535 through 570. At step 535 a request is received at the RAID controller. A decision is made as to whether the request is to read data from the RAID configuration or to write data to the RAID configuration (decision 540). If the request is to read data from the RAID configuration, then decision 540 branches to the “read” branch whereupon, at step 550, the RAID controller identifies the responsive data that is stored on the active (non-selected) drives using the redundancy provided by the RAID algorithm to get data from the active drives that would otherwise have been retrieved from the selected (inactive drive). The responsive data retrieved from the non-selected (active) drives is returned to the requestor at step 555.

Returning to decision 540, if the request was to write data to the RAID configuration, then decision 540 branches to the “write” branch whereupon, at step 560, the RAID controller identifies data blocks to be written to both the active drives and the inactive drive. At step 560, the data destined to be written to the active (non-selected) drives is written to the active drives at block addresses determined by the RAID algorithm. At step 570, the data blocks destined for the inactive (selected) drive are written to memory area 330 along with the data block addresses corresponding to the data blocks.

After the request has been handled by the RAID controller, a decision is made as to whether it is time to reactivate the inactive (selected) drive (decision 580). If it is not time to reactivate the selected drive, then decision 580 branches to the “no” branch which loops back to receive the next request at the RAID controller and handle it as described above. This looping continues until it is time to reactivate the selected drive, at which point decision 580 branches to the “yes” branch whereupon, at predefined process 590, the selected drive is reactivated (see FIG. 6 and corresponding text for processing details). Processing then loops back to the beginning of the routine to determine if it is time to inactivate one of the drives (e.g., the next drive in the RAID series, etc.).

FIG. 6 is a flowchart showing steps by the RAID controller to reactivate a drive that is currently inactive. Processing commences at 600 whereupon, at step 610, the RAID controller buffers incoming read and write requests until the selected drive has been reactivated with newly arriving requests stored in buffer memory 620.

At step 630, the selected drive is activated (e.g., powered on, etc.). At step 640, the first entry from memory area 300 is selected with each entry providing a data block address and a data block with the data block address providing the address at which the data block is to be written to the selected drive. At step 650, the data block is written to the selected drive at the corresponding data block address. A decision is made as to whether there are more data entries in memory area 300 to process (decision 660). If there are more entries to process, then decision 660 branches to the “yes” branch which loops back to select the next entry from memory area 300 with the next entry providing the next data block address and data block to be written to the selected drive. This looping continues until all of the entries from memory area 300 have been processed so that all of the writes that were destined to the selected drive while the drive was inactive have been written to the selected drive. When there are no more entries in memory area 300 that need to be processed, then decision 660 branches to the “no” branch.

At step 670, the requests received while the selected drive was being reactivated and updated with the data stored in memory area 300 are retrieved from buffer memory 620. These buffered requests are processed using normal RAID (read/write) operations using all of the (now active) drives. Once the buffered requests have been processed, then processing returns to the calling routine (see FIG. 5) at 695.

One of the preferred implementations of the invention is a client application, namely, a set of instructions (program code) or other functional descriptive material in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive). Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps. Functional descriptive material is information that imparts functionality to a machine. Functional descriptive material includes, but is not limited to, computer programs, instructions, rules, facts, definitions of computable functions, objects, and data structures.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A machine-implemented method comprising:
inactivating a selected drive, wherein the selected drive is one of a plurality of drives included in a RAID configuration;
processing a plurality of write requests to the RAID configuration while the selected drive is inactive, the processing of each of the write requests further comprising:
identifying a plurality of data blocks destined to be written to the selected drive, wherein the identifying includes identifying a data block address corresponding to each of the plurality of data blocks; and
writing the data block destined to the selected drive to a memory area outside of the RAID configuration, wherein the writing further includes writing the data block address corresponding to the data block destined to the selected drive;
reactivating the selected drive after a period of time, wherein the reactivation further comprises:
reading one or more data block addresses and their corresponding data blocks from the memory area; and
writing each of the read data blocks to the selected drive at the data block address corresponding to the respective data blocks.

2. The method of claim 1 further comprising:
receiving, from a requestor, a read request while the selected drive is inactive;
identifying a responsive data stored on one or more non-selected drives based on a RAID algorithm that corresponds to the RAID configuration, wherein the responsive data corresponds to the read request;
retrieving the responsive data from the non-selected drives; and
returning the retrieved responsive data to the requestor.

3. The method of claim 1 further comprising:
cycling through the plurality of drives so that, periodically, each of the drives is the selected drive.

4. The method of claim 1 wherein the memory area is a nonvolatile memory included in a RAID controller that manages the RAID configuration, wherein the RAID configuration provides data redundancy, wherein the RAID configuration corresponds to a RAID algorithm, and wherein the method further comprises:
identifying a plurality of data blocks destined to be written to each of the drives included in the RAID configuration including the selected drive, wherein the identifying is based on the RAID algorithm and further includes identifying a data block address corresponding to each of the plurality of data blocks; and
writing the data blocks destined to one or more non-selected drives to the non-selected drives at the corresponding data block addresses.

5. The method of claim 1 wherein the reactivating further comprises:
buffering incoming requests to a buffer memory while the data blocks are being read from the memory area and written to the selected drive; and
processing the buffered requests from the buffer memory after the data blocks stored in the memory have been written to the selected drive.

6. The method of claim 1 further comprising:
prior to inactivating the selected drive, selecting the selected drive based on an inactivation schedule that includes an inactive time corresponding to each of the plurality of drives included in the RAID configuration.

7. The method of claim 6 further comprising:
after the reactivation of the selected drive, selecting a second selected drive based on the inactivation schedule, wherein the processing of the write requests is performed on the second selected drive for a second time period and wherein the reactivation is performed on the second drive after the second time period has elapsed.

8. An information handling system comprising:
one or more processors;
a plurality of drives accessible by at least one of the processors wherein the drives are in a RAID configuration, wherein the RAID configuration provides data redundancy, and wherein the RAID configuration corresponds to a RAID algorithm;
a memory accessible by at least one of the processors;
a set of instructions stored in the memory and executed by at least one of the, wherein the set of instructions perform actions of:
inactivating a selected one of the plurality of drives;
processing a plurality of write requests to the RAID configuration while the selected drive is inactive, the processing of each of the write requests further comprising:
identifying a plurality of data blocks destined to be written to each of drive, wherein the identifying is based on the RAID algorithm and further includes identifying a data block address corresponding to each of the plurality of data blocks;
writing the data blocks destined to one or more non-selected drives to the non-selected drives at the corresponding data block addresses; and
writing the data block destined to the selected drive to a memory area of the memory, wherein the writing further includes writing the data block address corresponding to the data block destined to the selected drive;
reactivating the selected drive after a period of time, wherein the reactivation further comprises:
reading one or more data block addresses and their corresponding data blocks from the memory area; and
writing each of the read data blocks to the selected drive at the data block address corresponding to the respective data blocks.

9. The information handling system of claim 8 wherein the set of instructions performs additional actions comprising:
receiving, from a requestor, a read request while the selected drive is inactive;
identifying a responsive data stored on one or more non-selected drives based on a RAID algorithm that corresponds to the RAID configuration, wherein the responsive data corresponds to the read request;
retrieving the responsive data from the non-selected drives; and
returning the retrieved responsive data to the requestor.

10. The information handling system of claim 8 wherein the set of instructions performs additional actions comprising:
cycling through the plurality of drives so that, periodically, each of the drives is the selected drive.

11. The information handling system of claim 8 wherein the memory area is a nonvolatile memory, and wherein the information handling system is a RAID controller that manages the RAID configuration, wherein the RAID configuration provides data redundancy, wherein the RAID configuration corresponds to a RAID algorithm, and wherein the set of instructions performs additional actions comprising:
identifying a plurality of data blocks destined to be written to each of the drives included in the RAID configuration including the selected drive, wherein the identifying is based on the RAID algorithm and further includes identifying a data block address corresponding to each of the plurality of data blocks; and
writing the data blocks destined to one or more non-selected drives to the non-selected drives at the corresponding data block addresses.

12. The information handling system of claim 8 wherein the reactivating includes further actions comprising:
buffering incoming requests to a buffer memory while the data blocks are being read from the memory area and written to the selected drive; and
processing the buffered requests from the buffer memory after the data blocks stored in the memory have been written to the selected drive.

13. The information handling system of claim 8 wherein the set of instructions performs additional actions comprising:
prior to inactivating the selected drive, selecting the selected drive based on an inactivation schedule that includes an inactive time corresponding to each of the plurality of drives included in the RAID configuration.

14. The information handling system of claim 13 wherein the set of instructions performs additional actions comprising:
after the reactivation of the selected drive, selecting a second selected drive based on the inactivation schedule, wherein the processing of the write requests is performed on the second selected drive for a second time period and wherein the reactivation is performed on the second drive after the second time period has elapsed.

15. A computer program product stored in a computer readable medium, comprising functional descriptive material that, when executed by an information handling system, causes the information handling system to perform actions comprising:
inactivating a selected drive, wherein the selected drive is one of a plurality of drives included in a RAID configuration, wherein the RAID configuration provides data redundancy, and wherein the RAID configuration corresponds to a RAID algorithm;
processing a plurality of write requests to the RAID configuration while the selected drive is inactive, the processing of each of the write requests further comprising:
identifying a plurality of data blocks destined to be written to each of the drives included in the RAID configuration including the selected drive, wherein the identifying is based on the RAID algorithm and further includes identifying a data block address corresponding to each of the plurality of data blocks;
writing the data blocks destined to one or more non-selected drives to the non-selected drives at the corresponding data block addresses; and
writing the data block destined to the selected drive to a memory area outside of the RAID configuration, wherein the writing further includes writing the data block address corresponding to the data block destined to the selected drive;
reactivating the selected drive after a period of time, wherein the reactivation further comprises:
reading one or more data block addresses and their corresponding data blocks from the memory area; and
writing each of the read data blocks to the selected drive at the data block address corresponding to the respective data blocks.

16. The computer program product of claim 15 wherein the functional descriptive material causes the information handling system to perform further actions comprising:
receiving, from a requestor, a read request while the selected drive is inactive;
identifying a responsive data stored on one or more non-selected drives based on a RAID algorithm that corresponds to the RAID configuration, wherein the responsive data corresponds to the read request;
retrieving the responsive data from the non-selected drives; and
returning the retrieved responsive data to the requestor.

17. The computer program product of claim 15 wherein the functional descriptive material causes the information handling system to perform further actions comprising:
cycling through the plurality of drives so that, periodically, each of the drives is the selected drive.

18. The computer program product of claim 15 wherein the memory area is a nonvolatile memory included in a RAID controller that manages the RAID configuration, wherein the RAID configuration provides data redundancy, wherein the RAID configuration corresponds to a RAID algorithm, and wherein the functional descriptive material causes the information handling system to perform further actions comprising:
identifying a plurality of data blocks destined to be written to each of the drives included in the RAID configuration including the selected drive, wherein the identifying is based on the RAID algorithm and further includes identifying a data block address corresponding to each of the plurality of data blocks; and
writing the data blocks destined to one or more non-selected drives to the non-selected drives at the corresponding data block addresses

19. The computer program product of claim 15 wherein the functional descriptive material that performs the reactivating causes the information handling system to perform further actions comprising
buffering incoming requests to a buffer memory while the data blocks are being read from the memory area and written to the selected drive; and
processing the buffered requests from the buffer memory after the data blocks stored in the memory have been written to the selected drive.

20. The computer program product of claim 15 wherein the functional descriptive material causes the information handling system to perform
prior to inactivating the selected drive, selecting the selected drive based on an inactivation schedule that includes an inactive time corresponding to each of the plurality of drives included in the RAID configuration; and
after the reactivation of the selected drive, selecting a second selected drive based on the inactivation schedule, wherein the processing of the write requests is performed on the second selected drive for a second time period and wherein the reactivation is performed on the second drive after the second time period has elapsed.
